(19) United States
(12) Patent Application Publication
(10) Pub. No.: US 2016/0034721 A1
(43) Pub. Date: Feb. 4, 2016

(54) STORAGE SYSTEM AND STORAGE SYSTEM CONTROL METHOD

(71) Applicant: HITACHI, LTD., Tokyo (JP)

(72) Inventors: Mioko MORIGUCHI, Tokyo (JP); Hirotaka NAKAGAWA, Tokyo (JP); Hiroshi NASU, Tokyo (JP)

(73) Assignee: HITACHI, LTD., Tokyo (JP)

(21) Appl. No.: 14/655,201

(22) PCT Filed: Mar. 11, 2013
(86) PCT No.: PCT/JP2013/056643

§ 371 Date: Jun. 24, 2015

(51) Int. Cl. G06F 21/80; G06F 21/74; H04L 9/08; G06F 12/14; G06F 21/62

(52) U.S. Cl. CPC G06F 21/80; G06F 12/1408; G06F 21/6218; H04L 9/0894; G06F 21/74; G06F 2212/1052

(57) ABSTRACT

The present invention curbs encryption key information used in a virtual logical volume and improves security. A storage management function 33201 is configured to provide to a host computer a virtual logical volume 327 created on the basis of a pool volume 324. The storage management function is configured to allocate a prescribed page from among pages in the pool volume to a virtual logical volume in accordance with a write request from the host computer. The storage management function is configured to select a page to be allocated to the virtual logical volume on the basis of information regarding encryption key information associated with a page that has been allocated to the virtual logical volume and information regarding encryption key information associated with a page capable of being allocated to the virtual logical volume from the pages managed in the pool.

### TECHNICAL FIELD

The present invention relates to a storage system and a storage system control method.

### BACKGROUND ART

The so-called Thin Provisioning function, which provides a virtualized logical volume (virtual volume) to a host computer, and, triggered by a write request from the host computer, dynamically allocates a storage area (page) to the virtual volume, is well known (PTL 1).

In addition, dynamic tier control technology configured so as to provide a pool for hierarchically managing a plurality of types of storage areas with either different performance capabilities or bit costs in a storage apparatus having the Thin Provisioning function, and moving data between the tiers is also known (PTL 2).

Additionally, a technique for encrypting and storing write data from a host computer in a storage medium, and when reading the encrypted data from the storage medium, reading the data from the storage medium while performing decoding and sending the decoded data to the host computer is also known (PTL 3).

### CITATION LIST

### Patent Literature

[PTL 1]
US2009/0043982
[PTL 2]
US2007/0055713
[PTL 3]
US2009/0010432

### SUMMARY OF INVENTION

### Technical Problem

In the prior art, when a write of new data to a virtual volume occurs, any logical volume from among the logical volumes managed in the pool (pool volume) is dynamically selected, and a storage area (page) of this logical volume is allocated to the virtual volume. The virtual volume write data is actually written in the logical volume managed by the pool.

The logical volume for storing the data is dynamically selected from inside the pool at either the time of the write to the virtual volume or at data migration. The type of encryption key used by the storage medium is not taken into account when selecting the logical volume that is to be the data storage destination.

Data for a plurality of different virtual volumes can be stored in a logical volume that makes up the pool, and as such, in the unlikely event that the encryption key used by the storage medium related to this logical volume should leak out, the affects of this leak will readily spread far and wide, making it impossible to accurately identify the extent of the impact.

With the above problem in mind, an object of the present invention is to provide a storage system and a storage system control method capable of enhancing security by selecting a logical storage area for allocating to a virtual logical volume by taking into account encryption key information corresponding to the logical storage area. A further object of the present invention is to provide a storage system and a storage system control method that, in addition to being able to reduce encryption information used in a virtual logical volume, are also able to present a corresponding relationship between a virtualized logical volume and encryption key information.

### Solution to Problem

A storage system related to one aspect of the present invention is configured to provide a virtual logical volume to a host computer, and comprises a plurality of storage devices for providing physical storage areas, and a controller, the controller is configured to manage a plurality of logical volumes configured on the basis of a physical storage area of either one or a plurality of storage devices and at least one pool for managing a plurality of logical storage areas of the plurality of logical volumes, to provide at least one virtual logical volume created on the basis of the plurality of logical storage areas being managed by the pool to the host computer, and to allocate any prescribed logical storage area from among the plurality of logical storage areas being managed by the pool to a virtual logical volume in accordance with a write request from the host computer, either a portion or all of the plurality of storage devices are configured to be able to encrypt data stored in the physical storage area by using respectively different encryption key information, and in a prescribed instance, to select a logical storage area for allocating to the virtual logical volume on the basis of first information regarding encryption key information associated with a logical storage area allocated to the virtual logical volume, and, from among the plurality of logical storage areas managed in the pool, second information regarding encryption key information associated with a logical storage area capable of being allocated to the virtual logical volume.

### BRIEF DESCRIPTION OF DRAWINGS

FIG. 1 is a schematic drawing showing an overview of the embodiments.

FIG. 2 is a block diagram of an information processing system that includes a storage apparatus.

FIG. 3 is a block diagram showing the logical configuration of a local memory of the storage apparatus.

FIG. 4(a) shows an example of the configuration of information for managing a key, and FIG. 4(b) shows an example of the configuration of information for managing a parity group.

FIG. 5(a) shows an example of the configuration of information for managing an LDEV, and FIG. 5 (b) shows an example of the configuration of information for managing a pool.

FIG. 6(a) shows an example of the configuration of information for managing a VVOL, FIG. 6(b) shows an example of a list for managing a key related to a page, and FIG. 6(c) shows an example of a list for managing a correspondence ratio between a key used in a VVOL and a key used in a page.

FIG. 7 is a flowchart showing a process for allocating a page at the time of a data write to a VVOL.

FIG. 8 is a flowchart showing a process for creating a list of keys related to a VVOL.

FIG. 9 is a flowchart showing a process for creating a list of keys related to a page.

FIG. 10 is a block diagram showing the logical configuration of a local memory in a storage apparatus related to a second embodiment.

FIG. 11 is an example of information for the managing of whether each volume is enciphered for each VVOL.

FIG. 12 is a flowchart showing a process for allocating a page at the time of a data write to a VVOL.

FIG. 13 is a flowchart showing a process for selecting a page, from among pages given as allocation candidates, so as to minimize the types of keys used.

FIG. 14 is a block diagram showing the logical configuration of a local memory in a storage apparatus related to a third embodiment.

FIG. 15 is an example of information for the managing of whether each volume is enciphered for each tier of a VVOL.

FIG. 16 is a flowchart showing a process for allocating a page at the time of a data write to a VVOL.

FIG. 17 is a flowchart related to a fourth embodiment showing a process for selecting a migration-destination page at the time of a data migration.

### DESCRIPTION OF EMBODIMENTS

The embodiments of the present invention will be described hereinbelow by referring to the attached drawings. However, it should be noted that the embodiments are merely examples for realizing the present invention, and are not intended to limit the technical scope of the present invention. The plurality of characteristic features disclosed in the embodiments can be combined in various ways.

In this specification, information used in the embodiments is described using expressions such as “aaa table”, but the present invention is not limited thereto, and, for example, other expressions, such as “aaa list”, “aaa database” and “aaa queue” may also be used. The information used in the embodiments may be called “aaa information” to show that it is not dependent on the data structure.

When describing the content of the information used in the embodiments, the expressions “identification information”, “identifier”, “name”, and “ID” are used, but these expressions are interchangeable.

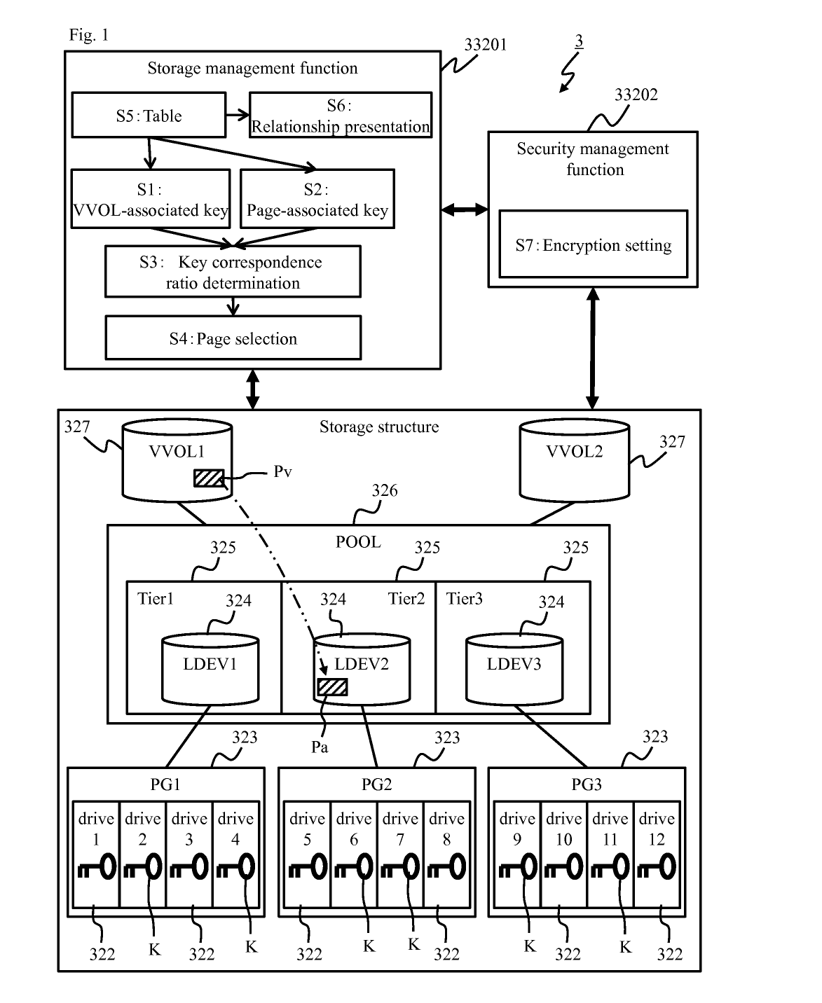

FIG. 1 is a schematic diagram showing an overview of the embodiments. FIG. 1 is a drawing that has been prepared to understand the embodiments, but the present invention is not limited to the configuration shown in FIG. 1. Even a configuration that does not comprise a part of the configuration shown in FIG. 1 is included in the scope of the present invention.

As described hereinbelow, in a storage system 3 that has a function for encrypting data, the embodiments are configured to select a storage area for allocating to a VVOL 327 by taking into account an encryption key used in the VVOL 327 in a prescribed instance.

That is, the embodiments are configured to select a storage area for allocating to a VVOL 327 on the basis of the correspondence ratio between an encryption key used in the encryption of data that has been stored in a VVOL 327 and an encryption key to be used for an allocatable storage area.

In addition, the embodiments are configured to manage the corresponding relationship of the VVOL 327 with the encryption key, and to be able to output this corresponding relationship to an external apparatus.

Thus, the embodiments are configured to be able to reduce the number of encryption keys used in the encryption of data written to the same VVOL 327, and as such, even in the unlikely case where an encryption key has leaked out, to be able to curb the extent of the impact thereof and to enhance security. In addition, since the embodiments make it possible to provide the corresponding relationship between an encryption key and a VVOL 327, usability is enhanced by the fact that a system administrator or other such user can readily ascertain the extent of the impact of the encryption key.

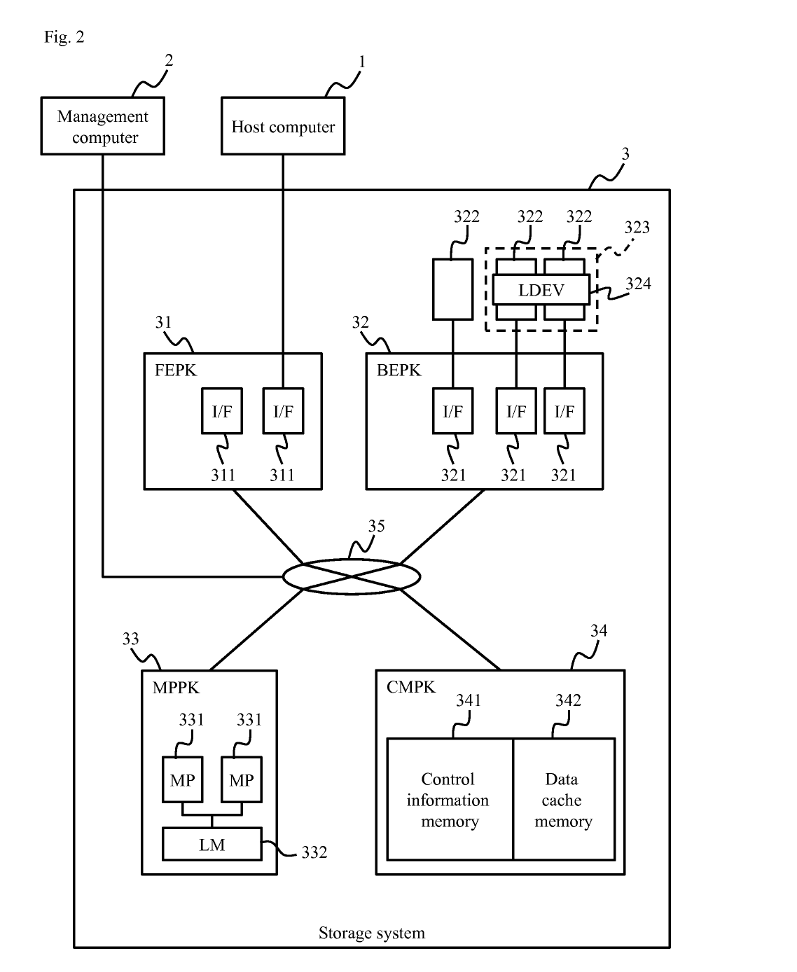

The storage system. 3 shown in FIG. 1 will be explained in detail below using FIG. 2 and subsequent drawings. In FIG. 1, the description will focus on the storage structure and control structure of the storage system 3.

The storage structure will be described first. The storage system 3 comprises a plurality of storage devices 322. For example, various storage devices capable of reading and writing data, such as a hard disk device, a semiconductor memory device, an optical disk device, a magneto-optical disk device and so forth, can be used as the storage device 322.

When a hard disk device is used as the storage device, for example, a Fibre Channel (FC) disk, a Small Computer System Interface (SCSI) disk, a SATA disk, an AT Attachment (ATA) disk, a Serial Attached SCSI (SAS) disk and so forth can be used. Also, for example, a variety of storage devices, such as a flash memory, a Ferroelectric Random Access Memory (FeRAM), a Magnetoresistive Random Access Memory (MRAM), an Ovonic Unified Memory, and a RRAM (registered trademark) can also be used.

Each storage device 322 is configured to use a respectively different encryption key K, and can individually encrypt storage content. In the example shown in FIG. 1, encryption processing is implemented on all of the storage devices 322, but the present invention is not limited thereto, and the configuration may be such that only a portion of the plurality of storage devices 322 performs encryption.

A parity group 323 is managed by grouping together the physical storage areas of a plurality of storage devices 322. A logical volume 324 is created by segmenting the physical storage area being managed in the parity group 323 into a storage area of a prescribed size. As used here, prescribed size may be a fixed value or a variable value.

A page is a unit of a storage area allocated to a VVOL 327, and, for example, can also be called a “prescribed-size storage area (logical storage area)”. For convenience of explanation, the prescribed-size storage area of a VVOL 327 may be called a virtual page Pv, and a prescribed-size storage area of a logical volume 324 stored in a pool 326 may be called an actual page Pa.

The pool 326 is configured to provide a logical storage area (page) to a VVOL 327, and to manage a plurality of logical volumes 324 as a pool volume. The performance (response performance, redundancy, and so forth) and bit cost of each logical volume 324 will differ in accordance with the performance of the storage device 322 constituting the basis of the logical volume 324 and the configuration of the parity group 323 (number of storage devices, RAID level, and so forth).

Accordingly, the pool 326 comprises a plurality of tiers 325 corresponding to performance capabilities and so forth. A logical volume 324 having performance capabilities suitable for the tier belongs to each tier 325. For example, high-performance logical volumes are collected together in a first tier, medium-performance logical volumes are collected together in a second tier, and low-performance logical volumes are collected together in a third tier.

A storage management function 33201 is an example of a “controller”. The controller is the MPPK in FIG. 2, and the functions described hereinbelow are realized by an MP operating on the basis of information in an LM. The storage management function 33201, together with a security management function 33202, may configure the “controller”. The storage management function 33201 is configured to control the storage system 3, and, for example, is in charge of processing a command received from the host computer, configuring the parity group 323, configuring the logical volume 324, configuring the pool 326, and configuring the VVOL 327 and so forth.

The storage management function 33201 comprises a function S1 for acquiring information about an encryption key associated with a VVOL, a function S2 for acquiring information about an encryption key associated with a page, a function S3 for determining the correspondence ratio between an encryption key being used in a VVOL and an encryption key of an allocation candidate page, and a function S4 for selecting and using a page in a VVOL 327.

The storage management function 33201 is configured to check the degree to which an encryption key used in an actual page Pa that has been allocated to a VVOL 327 corresponds to an encryption key to be used in an allocation candidate page Pa, and to select a page Pa with a high degree of correspondence. This makes it possible to curb the number of encryption keys used in a VVOL 327. In other words, since it is possible to curb the use of one encryption key in a large number of VVOLs 327, in the unlikely event that a portion of the encryption keys used in the storage system 3 should leak out, the extent of the impact resulting from this leak can be minimized.

In addition, the storage management function 33201 also comprises a function S5 for managing a management table, and a function S6 for creating information regarding an encryption key associated with a VVOL 327 on the basis of the management table and presenting this information via an external apparatus.

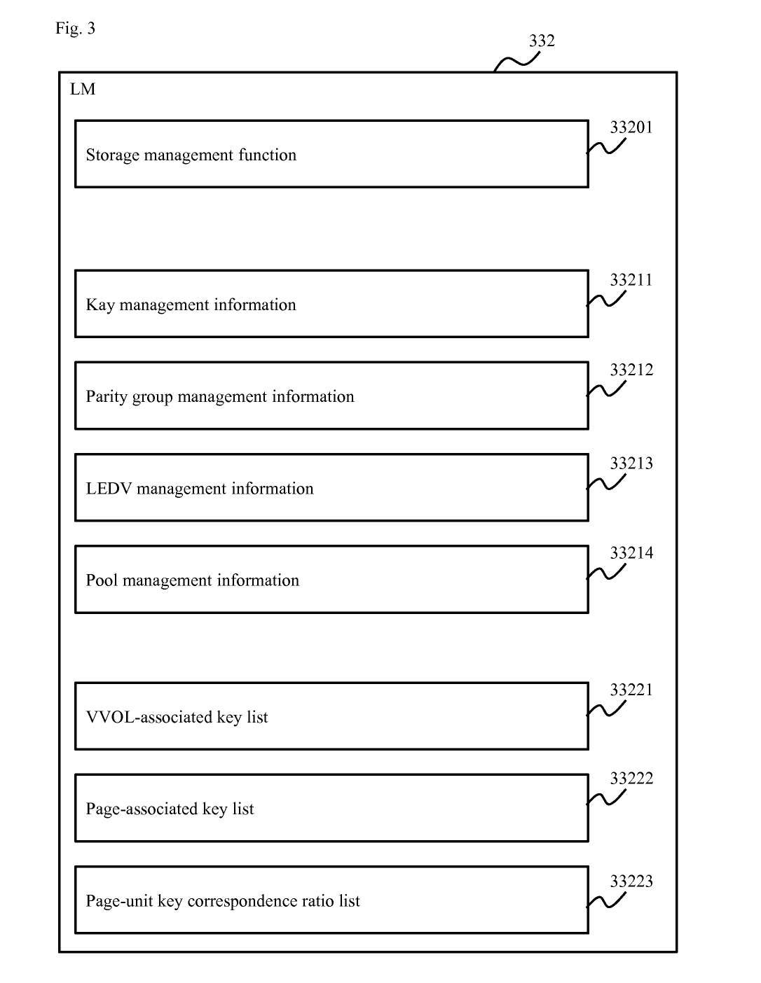

The table management function S5 is configured to manage an encryption key information management table for managing the encryption key information configured in each of a plurality of storage devices, and a corresponding relationship management table for managing the corresponding relationship between a virtual page Pv in a VVOL 327, an actual page Pa in the pool 326, and a storage device 322. One example of the encryption key information management table is the key management information 33211 of FIG. 3. One example of the corresponding relationship management table is the parity group management information 33212, LDEV management information 33213, and pool management information 33214 in FIG. 3.

A user can readily ascertain the utilization status of an encryption key for a VVOL 327 by outputting the information related to the encryption key associated with the VVOL 327 to an external apparatus. Therefore, the extent of the impact in the unlikely event that an encryption key is leaked out can be easily identified beforehand, thereby enhancing user usability. One example of an external apparatus is a management computer 2, which will be described further below. But the present invention is not limited thereto, and, for example, the configuration may be such that the corresponding relationship is outputted to a mobile telephone, a portable information terminal, a personal computer, a printer, a display, a digital camera, and so forth.

The security management function 33202 is configured to manage the security of data to be stored in the storage system 3. The security management function 33202 comprises a function S7 for configuring whether or not encryption will be performed for each VVOL or for each tier included in a VVOL. A mode for encrypting data using an encryption key is called an encryption mode, and a mode for handling data as plain text is called a normal mode. The configuration of the storage system 3 will be described in detail below.

### Embodiment 1

A first embodiment will be described using FIGS. 2 through 9. In this embodiment, an example is given of a case in which all of the pool volumes 324 are encrypted. In this embodiment, a page is allocated so as to minimize the number of encryption keys used when a write request has been received for a VVOL 327 and a page has yet to be allocated to the write destination. In this embodiment, the correspondence ratio between a key that is already being used in the encryption of data stored in a VVOL 327 and a key to be used in the encryption of data to be stored in a candidate page to be allocated hereinafter is calculated, and a page with a high correspondence ratio is allocated to a VVOL 327. This makes it possible to curb the number of encryption keys to be used in the encryption of data to be stored in a VVOL 327.

An outline of the configuration of an information processing system that includes the storage system 3 is shown in FIG. 2. The information processing system, for example, comprises at least one host computer 1, at least one management computer 2, and at least one storage system 3.

The host computer 1 is configured to issue to the storage system 3 a command, such as either a write request or a read request, in accordance with a request from an application program. The management computer 2 is configured to manage the storage system 3, and to output to a screen the configuration and state of the storage system 3 and the utilization status of an encryption key. Also, a user can indicate various settings to the storage system 3 via the management computer 2.

The storage system 3, for example, comprises a host interface unit (FrontEnd PacKage (FEPK)) 31, a media interface unit (BackEnd PacKage (BEPK)) 32, a controller (Micro Processor PacKage (MPPK)) 33, and a shared memory unit (Cache Memory PacKage (CMPK)) 34. These packages 31 through 34 are connected to an internal network 35, and are able to communicate with one another. At least one of each of these packages 31 through 34 is provided.

The FEPK 31 has a plurality of host interfaces 311, and is coupled to the host computer 1 via a host interface 311. In the drawing, interface is abbreviated as I/F. The FEPK 31 is coupled to the host computer 1 via either a communication path that uses an Internet Protocol (IP) network, such as the Internet or a Local Area Network (LAN), or a communication path that uses a Fibre Channel-Storage Area Network (FC-SAN). The FEPK 31 is configured to mediate the exchange of either read process target data or write process target data between the host computer 1 and a volume.

The BEPK 32 has a plurality of media interfaces 321, and is coupled to a physical storage device 322 via a cable. The BEPK 32 is configured to mediate the exchange of either read process target data or write process target data between the internal network side and the physical storage device 322.

The CMPK 34 has a control information memory 341 and a data cache memory 342. The control information memory 341 is configured to store information required in a process in the storage system 3, for example, control information and configuration information. The data cache memory 342 is configured to temporarily store either data to be written to the physical storage device 322, or data read from the physical storage device 322. The control information memory 341 and the data cache memory 342 are volatile memory, and, for example, may be a Dynamic Random Access Memory (DRAM). A volatile memory may be used by backing it up with a battery or the like.

The MPPK 33, for example, has a plurality of microprocessors (MP) 331, and a local memory (LM) 332. The microprocessors 331 and the local memory 332 are connected by a bus 333. The LM 332 is configured to store a portion of the control information being stored in the control information memory 341.

The MP 331 is configured to collect together a plurality of the same type of physical storage devices 322 to configure a parity group 323, and to segment a portion of the storage area in the parity group 323 into a Logical DEVice (LDEV) 324. The LDEV 324 is also called a logical volume.

The MP 331 is configured to configure a pool 326 for consolidating a plurality of LDEVs 324 as a single logical storage area. An LDEV 324 making up the pool 326 may be called a pool volume.

The MP 331 is configured to segment the pool 326 into a virtual volume 327 having an actual capacity of “0” and to provide this virtual volume 327 to the host computer 1. The host computer 1 is configured to use the virtual volume 327 provided from the storage system 3 as a logical volume. When a write process is performed from the host computer 1 to the virtual volume 327, the MP 331 is configured to select and allocate a page from the pool 326 in a case where an actual storage area (called either an actual page or a page) has not been allocated to the write destination.

FIG. 3 shows an example of the logical configuration of the LM 332 inside the MPPK 33. For example, in addition to the storage management function 33201, the LM 332 is configured to store various types of information 33211 through 33214 and 33221 through 33223 used by the storage management function 33201.

The key management information 33211 manages the corresponding relationship between an encryption key and an entity to which the encryption key has been allocated. Parity group management information 33212 manages a list of physical storage devices 322 configuring a parity group 323, and encryption settings of the parity group 323.

LDEV management information 33213 associatively manages identification information for identifying a LDEV 324 segmented from a parity group 323, an attribute of the LDEV 324, identification information of the parity group 323 to which the LDEV 324 belongs, and identification information for identifying a tier 325 to which the LDEV 324 belongs.

Pool management information 33124 associatively manages identification information for identifying a pool 326, identification information for identifying a page in the pool 326, identification information of the LDEV 324 to which this page belongs, identification information of the VVOL 327, which is the allocation destination of this page, and a logical address range (LBA Range) in the VVOL 327.

A VVOL-associated key list 33221 is a list of encryption keys used in the encryption of VVOL 327 data. A page-associated key list 33222 is a list of encryption keys used in the encryption of data to be stored in the pages of the pool 326.

A page-unit key correspondence ratio list 33223 is a list for managing, for each page, the degree of correspondence between an encryption key being used in a VVOL 327 and an encryption key to be used in an allocation candidate page. The page-unit key correspondence ratio list 33223 is for managing the correspondence ratio between an encryption key to be used in the encryption of data that will be stored in a page to be allocated and the encryption key already being used to encrypt data in the VVOL 327, when allocating a page to the VVOL 327.

There is no need for all of the information 33211 through 33214 and 33221 through 33223 shown in FIG. 3 to be prepared from the start. The VVOL associated key list 33221 and the page-associated key list 33222 may be created from the key management information 33211, the parity group management information 33212, and the LDEV management information 33213 and the pool management information 33214 as required. The page-unit key correspondence ratio list 33223 may be created at the time the VVOL associated key list 33221 and the page-associated key list 33222 are created.

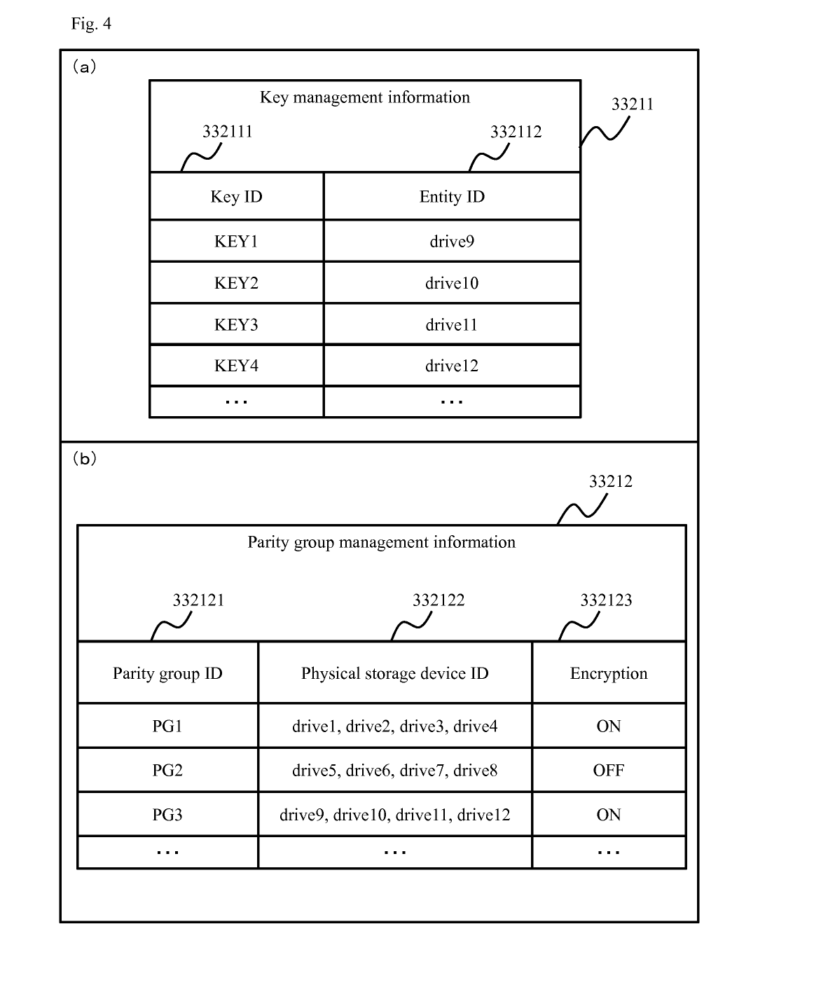

FIG. 4 shows examples of the key management information 33211 and the parity group management information 33212. As shown in FIG. 4(a), the key management information 33211 comprises a key ID column 332111 for managing identification information (ID) that enables a key to be uniquely identified, and an entity ID column 332112 for managing an ID that enables the entity (physical storage device 322) to which the associated key is allocated to be uniquely identified. Furthermore, in this embodiment, a key is allocated to each HDD, but a key may be allocated to each logical volume. In this case, the relationship between the key and the logical volume is managed using the table in FIG. 4(a).

As shown in FIG. 4(b), the parity group management information 33212 includes a parity group ID column 332121 for managing an ID that enables a parity group 323 to be uniquely identified, a physical storage device ID column 332122 for managing an ID that enables a physical storage device 322 making up a parity group 323 to be uniquely identified, and an encryption setting column 332123 denoting the encryption setting of the relevant parity group. When ON is configured in the encryption setting column 332123, each storage device 322 making up the parity group encrypts the storage contents in accordance with an encryption key and a prescribed encryption algorithm.

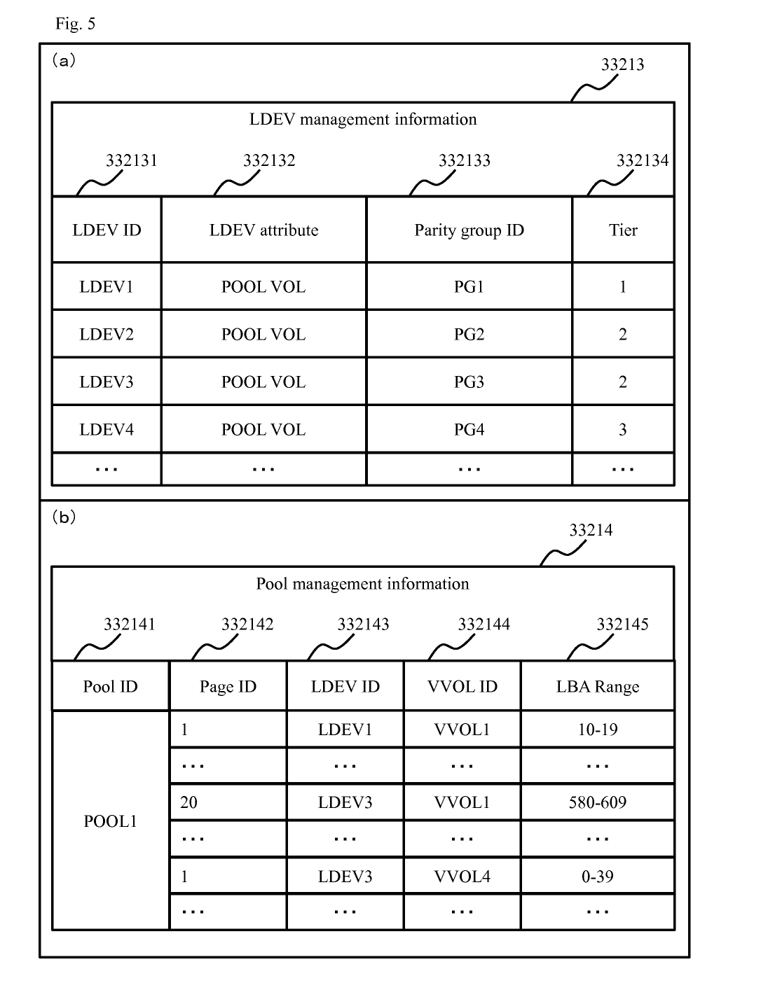

FIG. 5 shows examples of the LDEV management information 33213 and the pool management information 33214. As shown in FIG. 5(a), the LDEV management information 33213 includes an LDEV ID column 332131 for managing an ID that enables the LDEV to be uniquely identified, a LDEV attribute column 332132 for managing the attribute of the relevant LDEV, a parity group ID column 332133 for managing an ID that enables the parity group from which the relevant LDEV was segmented to be uniquely identified, and a tier column 332134. The tier column 332134 stores information showing the tier in which the relevant LDEV is configured when the LDEV is a pool volume.

As shown in FIG. 5(b), the pool management information 33214 includes a plurality of columns 332141 through 332145, which will each be explained below. A pool ID column 332141 is for managing an ID that enables a pool to be uniquely identified. A page ID column 332142 is for managing an ID that enables the page (actual page) actually storing the VVOL 327 data to be uniquely identified in the pool. An LDEV ID column 332143 is for managing an ID that enables the LDEV (pool volume) comprising the pool to be uniquely identified. A VVOL ID column 332144 is for managing an ID that enables the VVOL 327 to which a page has been allocated to be uniquely identified. An LBA Range column 332145 is for managing the range of data stored in a page, that is, the LBA range in the VVOL 327.

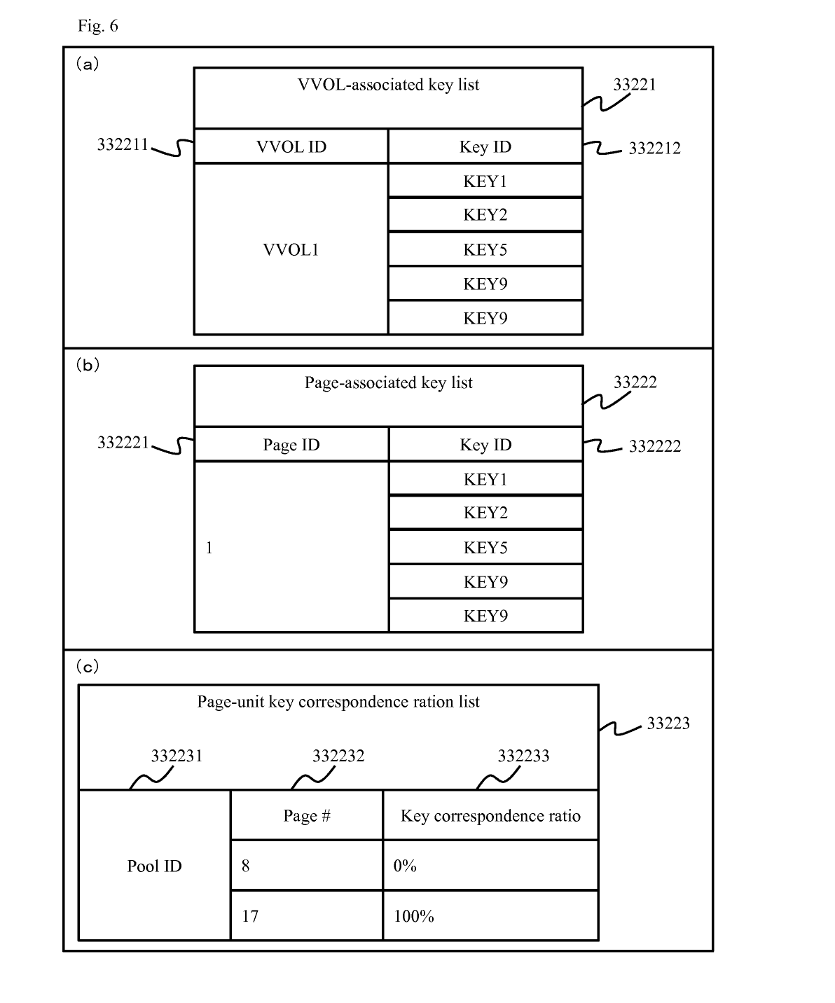

FIG. 6 shows examples of the VVOL-associated key list 33221, the page-associated key list 33222, and the page-unit correspondence ratio list 33223.

As shown in FIG. 6(a), the VVOL-associated key list 33221, for example, includes a VVOL ID column 332211 for managing an ID that enables the VVOL 327 to be uniquely identified, and a key ID column 332212 for managing an ID that enables the encryption key to be used in the encryption of data to be stored in the VVOL 327 to be uniquely identified.

As shown in FIG. 6(b), the page-associated key list 33222 includes a page ID column 332221 for managing an ID that enables the page that will actually store the data of the VVOL 327 to be uniquely identified in the pool, and a key ID column 332222 for managing an ID that enables the encryption key to be used in the encryption of data to be stored in the page to be uniquely identified.

As shown in FIG. 6(c), the page-unit key correspondence ratio list 33223 includes a pool ID column 332231 for managing an ID that enables the pool to be uniquely identified, a page ID column 332232 for managing an ID that enables the page that is to store the VVOL 327 data to be uniquely identified, and a key correspondence ratio column 332233. The key correspondence ratio column 332233 is configured to manage the correspondence ratio between the key to be used in the encryption of data stored in a page and the key already being used for encrypting the data of the VVOL 327 for storing data in the relevant page.

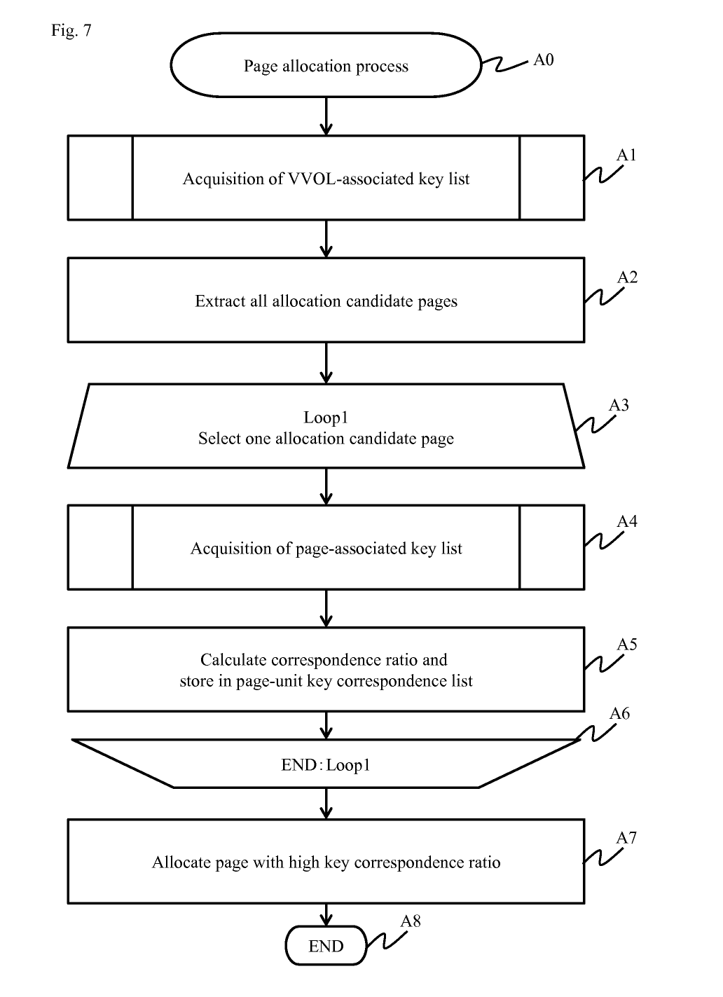

Examples of the operation of the storage system 3 will be described by referring to FIGS. 7 through 9. FIG. 7 is a flowchart showing the process when a new page Pa is allocated to a VVOL 327. Each of the following processes included in this processing is realized by the MP 331 in the MPPK 33 executing a computer program (the storage management function 33201) stored in the LM 332. Therefore, the entity in charge of processing may be any of the storage management function 33201, the MP 331, the MPPK 33, or the storage system 3. The storage management function 33201, which is an example of the “controller”, will be described here as the entity in charge of processing.

FIG. 7 describes a page allocation method in a case where there has been a write to a VVOL 327 in an environment in which all of the pool volumes 324 are encrypted. When an actual page Pa has yet to be allocated to the write-destination area (virtual page Pv) in the VVOL 327, the storage management function 33201 is configured to calculate the correspondence ratio between the key already being used in the encryption of the data being stored in the VVOL 327 and the key to be used in the encryption of data to be stored in the allocation candidate page. The storage management function 33201 is configured to curb the number of encryption keys to be used in the encryption of data to be stored in the VVOL 327 by allocating the page with the highest encryption key correspondence ratio to the VVOL 327. This operation will be described in detail below.

The storage management function 33201 is configured to start the processing upon receiving from the host computer 1 a write request for an area of the VVOL 327 to which a page has yet to be allocated (A0). The storage management function 33201 is configured to identify the VVOL 327 (target VVOL) for which there was a write request, and to acquire the VVOL-associated key list 33221 for the target VVOL 327 (A1).

The storage management function 33201 is configured to reference the pool management information 33214 and to extract all from high-priority pages to be allocated to the target VVOL 327 (A2). The extracted pages are called an allocation candidate page group. Priority signifies the order of preference for allocation to the VVOL, and, for example, the priority is higher for a page in a higher-level tier. The criterion for allocating pages in order from the higher-level tier is an example of a “prescribed extraction criterion”.

The storage management function 33201 is configured to calculate, in Loop 1 from Step A3 to Step A6, the correspondence ratio between an encryption key to be used in the encryption of data to be stored in an allocation candidate page and an encryption key described in the VVOL-associated key list 33221 acquired in Step A1, and to create a page-unit key correspondence ratio list 33223.

Specifically, the storage management function 33201 is configured to extract one allocation candidate page from the allocation candidate page group extracted in Step A2 (A3). The storage management function 33201 is configured to acquire the page-associated key list 33222 for the extracted allocation candidate page (A4).

The storage management function 33201 is configured to compare the VVOL-associated key list 33221 to the page-associated key list 33222, to calculate the ratio of encryption keys included in the page-associated key list 33222 that are included in the VVOL-associated key list 33221 as the key correspondence ratio, and to store the calculation result in the page-unit key correspondence ratio list 33223 (A5).

The storage management function 33201 is configured to end the Loop (A6) and advance to Step A7 when the Loop 1 processing has been performed for all the allocation candidate pages. In Step A7, the storage management function 33201 is configured to reference the page-unit key correspondence ratio list 33223, to select a page having a high page allocation priority, and, in addition, a high key correspondence ratio, to allocate the selected page to the VVOL 327, and to end the processing (A8). Loop 1 need not be applied to all the allocation candidate pages. For example, the relevant page may be determined as the page to be allocated at the time point when a page meeting a preconfigured threshold has been found.

The prioritization of either the page allocation priority or the key correspondence ratio can be preconfigured in the storage management function 33201, or can be configured in accordance with a user indication from the management computer 2. When the page allocation priority is given precedence over the key correspondence ratio, the response performance of the storage system 3 improves, but when the key correspondence ratio is given precedence over the page allocation priority, response performance for allocating a page belonging to a lower-level tier 325 to a VVOL 327 decreases. However, since it is possible to curb the number of encryption keys to be used by the VVOL 327 in this case, the extent of the compromise when an encryption key has leaked out can be reduced, thereby improving security.

When data is stored in a page with a correspondence ratio of less than 100%, it is possible to minimize the keys used in the encryption of data to be stored in the VVOL 327 by executing control so that the data to be stored in the page is encrypted with a key included in the VVOL-associated key list 33221.

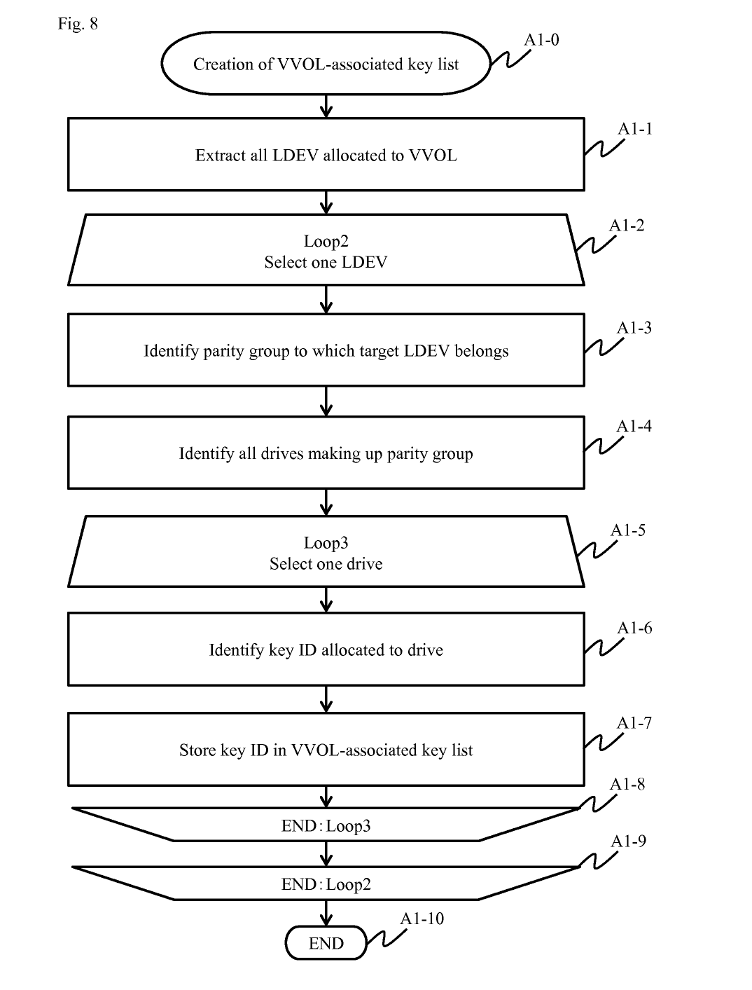

The process for creating the VVOL-associated key list 33221 will be described using FIG. 8. FIG. 8 is a flowchart showing the details of Step A1 in FIG. 7. The storage management function 33201 is configured to start the processing upon identifying the VVOL 327 for which a write request has occurred (A1-0). The storage management function 33201 is configured to reference the pool management information 33214, and to extract all the LDEVs 324 that are providing a page to the identified VVOL 327 (A1-1).

The storage management function 33201 is configured to identify, in Loop 2 from Step A1-1 to Step A1-10, the key used in the encryption of data being stored in the LDEV allocated to the VVOL 327, and to create the VVOL-associated key list 33221.

Specifically, the storage management function 33201 is configured to extract one LDEV from among all the LDEVs extracted in Step A1-1 (A1-2). The storage management function 33201 is configured to reference the LDEV management information 33213 for the extracted LDEV (target LDEV), and to identify the parity group 323 to which the target LDEV belongs (A1-3).

The storage management function 33201 is configured to reference the parity group management information 33212 and to identify all the physical storage devices 322 making up the parity group identified in Step A1-3 (A1-4).

The storage management function 33201 is configured to identify, in Loop 3 from Step A1-5 to A1-9, the encryption keys allocated to all the physical storage devices 322 identified in Step A1-4.

Specifically, the storage management function 33201 is configured to extract one storage device (target storage device) from all the physical storage devices 322 identified in Step A1-4 (A1-5). The storage management function 33201 is configured to reference the key management information 33211, to identify the key ID of the encryption key allocated to the target storage device 322 (A1-6), and to store the key ID in the VVOL-associated key list 33221 (A1-7). The storage management function 33201 is configured to end the Loop 3 when the Loop 3 processing has been performed for all the physical storage devices 322 identified in Step A1-4 (A1-8).

The storage management function 33201 is configured to end the Loop 2 when the Loop 2 processing has been performed for all the LDEVs extracted in Step A1-1 (A1-9), and to end this process (A1-10).

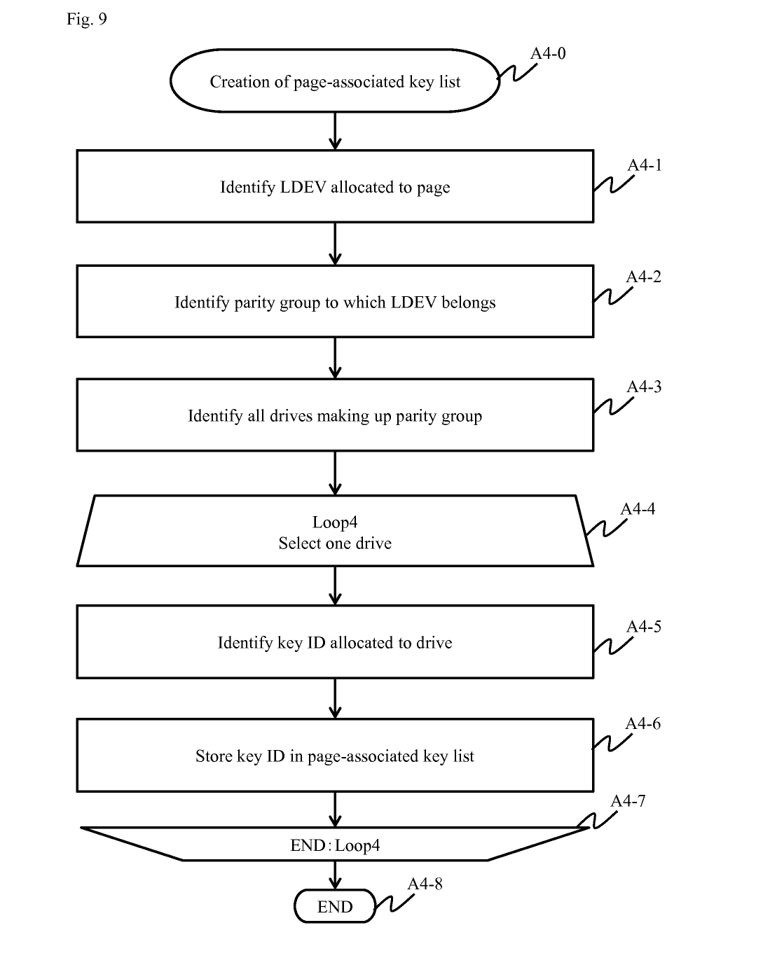

The process for creating the page-associated key list 33222 will be described using FIG. 9. FIG. 9 is a flowchart showing the details of Step A4 in FIG. 7.

The storage management function 33201 is configured to start this processing for the page (target page) upon identifying the allocation candidate page (A4-0). The storage management function 33201 is configured to reference the pool management information 33214 and to identify the LDEV allocated to the target page (A4-1).

The storage management function 33201 is configured to reference the LDEV management information 33213 and to identify the parity group to which the identified LDEV belongs (A4-2). The storage management function 33201 is configured to reference the parity group management information 33212 and to identify the physical storage devices 322 making up the identified parity group (A4-3).

The storage management function 33201 is configured to identify, in Loop 4 from Step A4-4 to Step A4-7, the encryption keys allocated to all the physical storage devices 322 identified in Step A4-3.

Specifically, the storage management function 33201 is configured to extract one storage device from all the physical storage devices 322 identified in Step A4-3 as the target storage device (A4-4). The storage management function 33201 is configured to reference the key management information 33211, to identify the key ID of the encryption key allocated to the target storage device 322 (A4-5), and to store the key ID in the page-associated key list 33222 (A4-6). The storage management function 33201 is configured to end Loop 4 when the processing of Loop 4 has been performed for all the physical storage devices 322 identified in Step A4-3 (A4-7) and to end the processing (A4-8).

According to this embodiment, which is configured in this manner, it is possible to curb the number encryption keys used in the VVOL 327, to limit the extent of a compromise in a case where an encryption key has leaked out, and to improve security. In addition, as described using FIG. 1, this embodiment makes it possible to visualize the corresponding relationship between the encryption key being used in the VVOL 327 and the storage device 322 and to output this relationship to the management computer 2 or the like, thereby making possible to increase the efficiency of user management tasks and to improve usability.

### Embodiment 2

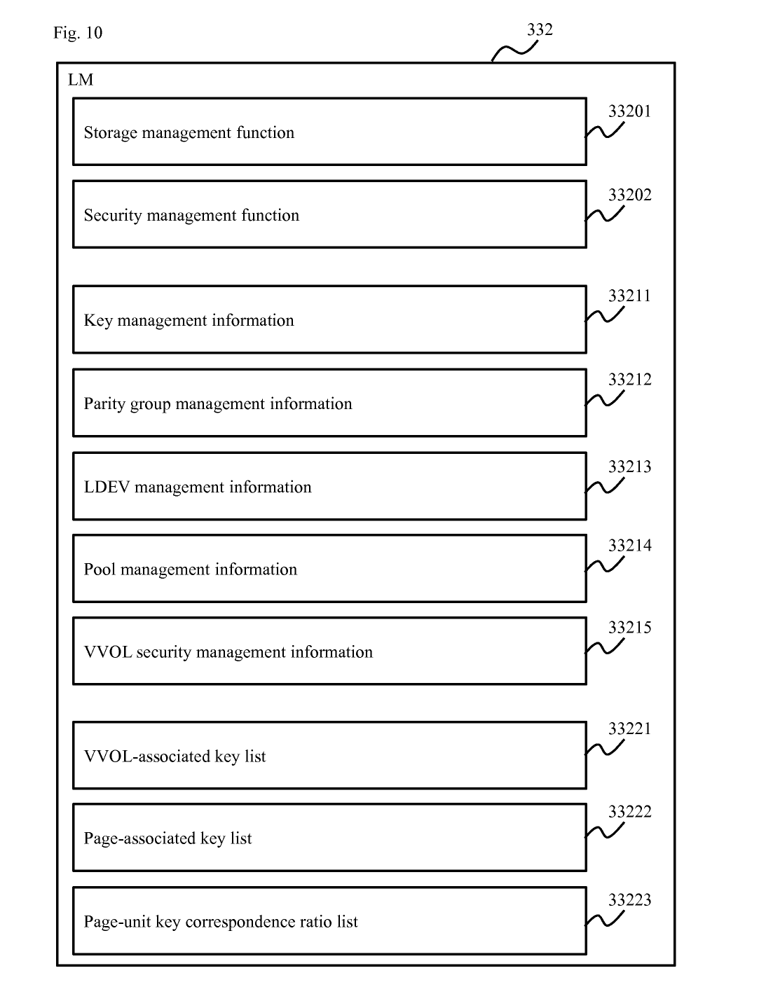

A second embodiment will be described using FIGS. 10 through 13. The following embodiments, to include this embodiment, correspond to variations of the first embodiment, and as such, will be described by focusing on the differences with the first embodiment. In this embodiment, a case that applies to an environment in which an encrypted pool volume 324 and an unencrypted pool volume 324 are intermixed is described.

In this embodiment, as described hereinbelow, when there is a write request for a VVOL 327, a page has yet to be allocated, and the VVOL 327 is operating in the encryption mode, a page is selected and allocated to the VVOL on the basis of the key correspondence ratio as was described in the first embodiment.

FIG. 10 shows the logical configuration of the LM 332 in the MPPK 33 in this embodiment. In addition to the example of the LM 332 logical configuration in the first embodiment shown in FIG. 3, the LM 332 of this embodiment also comprises a security management function 33202. The security management function 33202 comprises VVOL security management information 33215. The VVOL security management information 33215 is information for configuring the necessity of encryption processing for each VVOL 327. The management computer 2 is configured to be able to access the VVOL security management information 33215 via an interface provided by the security management function 33202. The user (system administrator) can access the VVOL security management information 33215 via the management computer 2, and either configure the encryption mode or configure the normal mode for each VVOL.

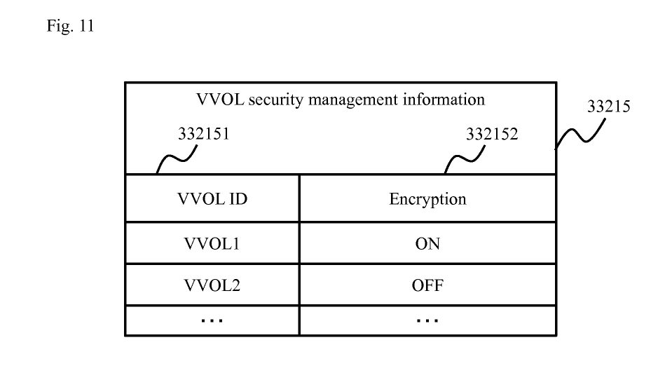

FIG. 11 shows an example of the configuration of the VVOL security management information 33215. The VVOL security management information 33215 includes a VVOL ID column 332151 for managing an ID that enables the VVOL 327 to be uniquely identified, and an encryption setting column 332152 for managing the necessity for performing encryption for the VVOL 327. A VVOL 327 for which ON is configured in the encryption setting column 332152 is operated in the encryption mode, and data written to this VVOL 327 is encrypted using the encryption key configured in the storage device 322 corresponding to the write destination. By contrast, a VVOL 327 for which OFF is configured in the encryption setting column 332152 is operated in the normal mode, and data written thereto is not encrypted.

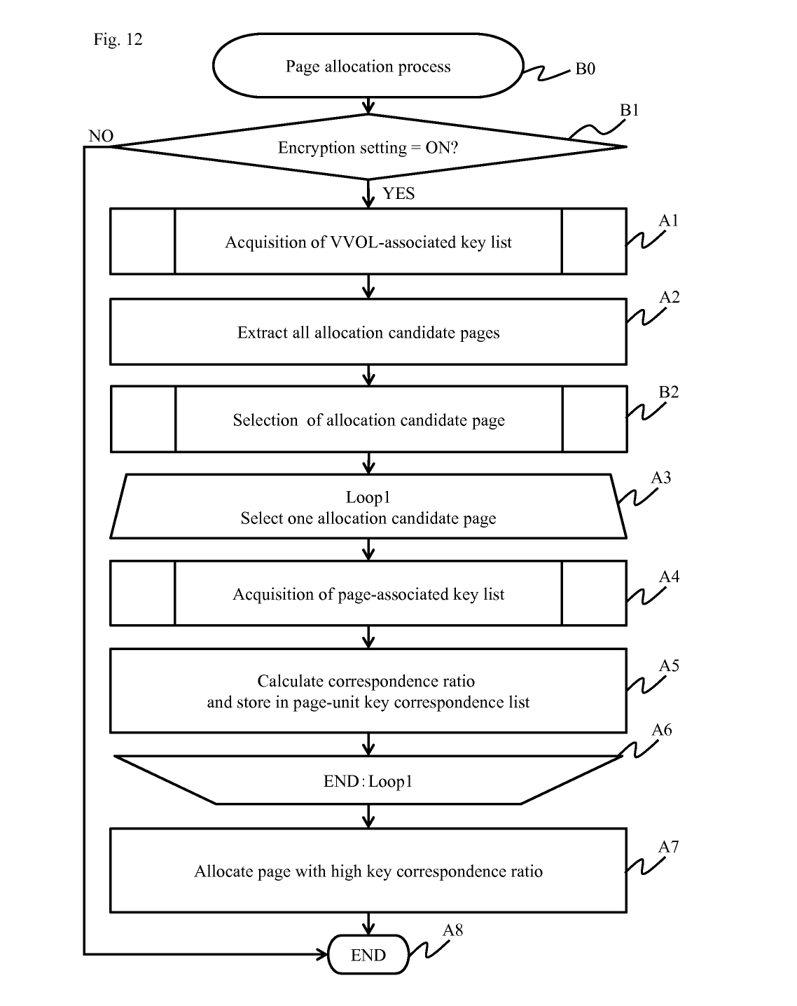

A method for allocating a page on the basis of the encryption setting configured in the VVOL 327 when there is a write request for the VVOL 327 will be described by referring to the flowchart of FIG. 12.

The storage management function 33201 is configured to start this process upon receiving a write request from the host computer 1 for an area to which a page has yet to be allocated within the storage space of the VVOL 327 (B0).

The storage management function 33201 is configured to reference the VVOL security management information 33215, to identify the encryption setting of the VVOL 327 (target VVOL) constituting the write request target, and to determine whether the encryption setting is ON (B1).

The storage management function 33201 is configured to end this processing when it has been determined that the encryption setting for the target VVOL 327 is OFF (B1: NO) (B10).

The storage management function 33201 is configured to perform a VVOL-associated key list acquisition process for the target VVOL 327 when it has been determined that the encryption setting for the target VVOL 327 is ON (B1: YES) (A1).

The storage management function 33201 is configured to reference the pool management information 33214, to extract all the allocation candidate pages (A2), and to perform selection processing on the extracted allocation candidate pages on the basis of the encryption setting (B2).

The storage management function 33201 performs Steps A3 through A7 for the allocation candidate page group for which the selection processing of Step B2 has been completed. The processing from Step A3 through A7 is the same as that described in the first embodiment, and as such, descriptions will be omitted.

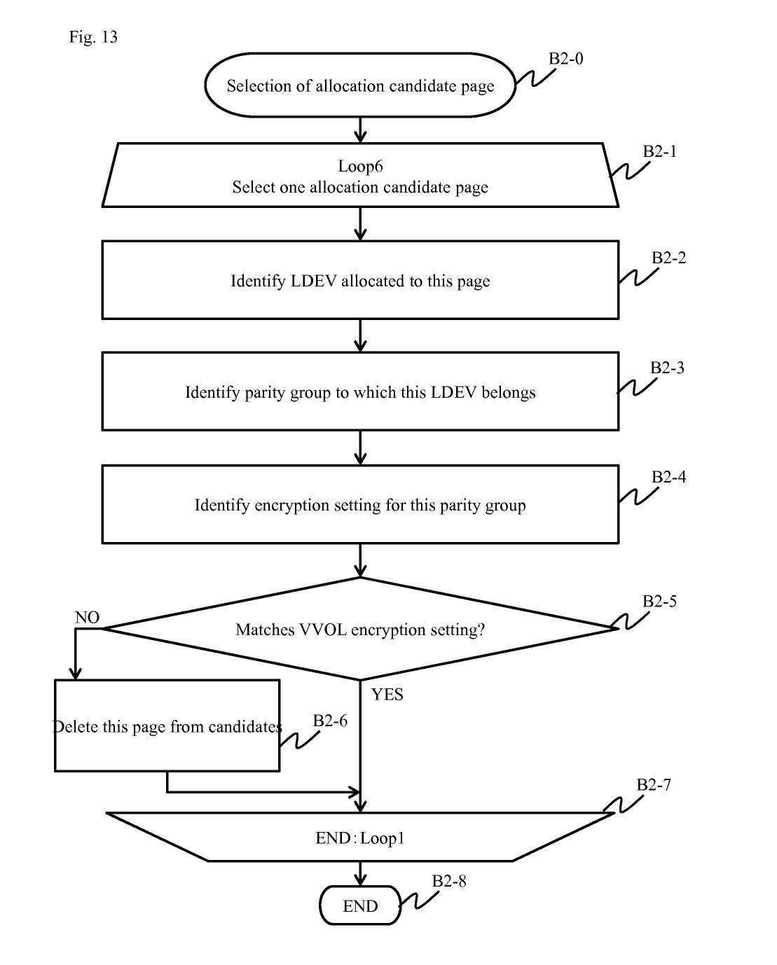

FIG. 13 is a flowchart showing the process for selecting the allocation candidate pages in accordance with the content of the encryption setting. FIG. 13 shows Step B2 of FIG. 12 in detail.

The storage management function 33201 is configured to extract, in Loop 6 from Steps B2-0 through B2-7, an allocation candidate page that corresponds to the encryption setting. The storage management function 33201 extracts one allocation candidate page (target candidate page) from the allocation candidate page group (B2-1).

The storage management function 33201 is configured to reference the pool management information 33214 for the target candidate page, and to identify the LDEV allocated to the target candidate page (B2-2). The storage management function 33201 is configured to reference the LDEV management information 33213, and to identify the parity group to which the identified LDEV belongs (B2-3).

The storage management function 33201 is configured to reference the parity group management information 33212 and to identify the encryption setting for the identified parity group (B2-4). The storage management function 33201 is configured to determine whether the encryption setting of the parity group identified in Step B2-4 corresponds to the encryption setting of the VVOL 327 identified in Step B2 (B2-5).

The storage management function 33201 is configured to delete the target candidate page from the allocation candidate page group (B2-6) when it has been determined that the encryption setting of the parity group does not correspond to the encryption setting of the VVOL 327 (B2-5: NO).

By contrast, the storage management function 33201 is configured to advance to the next step when it has been determined that the encryption setting of the parity group corresponds to the encryption setting of the VVOL 327 (B2-5: YES). The storage management function 33201 is configured to end the Loop 6 when the Loop 6 processing has been performed for all the pages in the allocation candidate page group (B2-8).

This embodiment, which is configured in this manner, also achieves the same operational advantage as the first embodiment. In addition, in this embodiment, a page is allocated on the basis of the correspondence ratio of the encryption key only to a VVOL that is performing encryption processing in an environment in which the necessity of encryption processing can be configured for each VVOL. Therefore, security can be efficiently improved in a storage system 3 in which a VVOL to be encrypted and a normal VVOL are intermixed.

### Embodiment 3

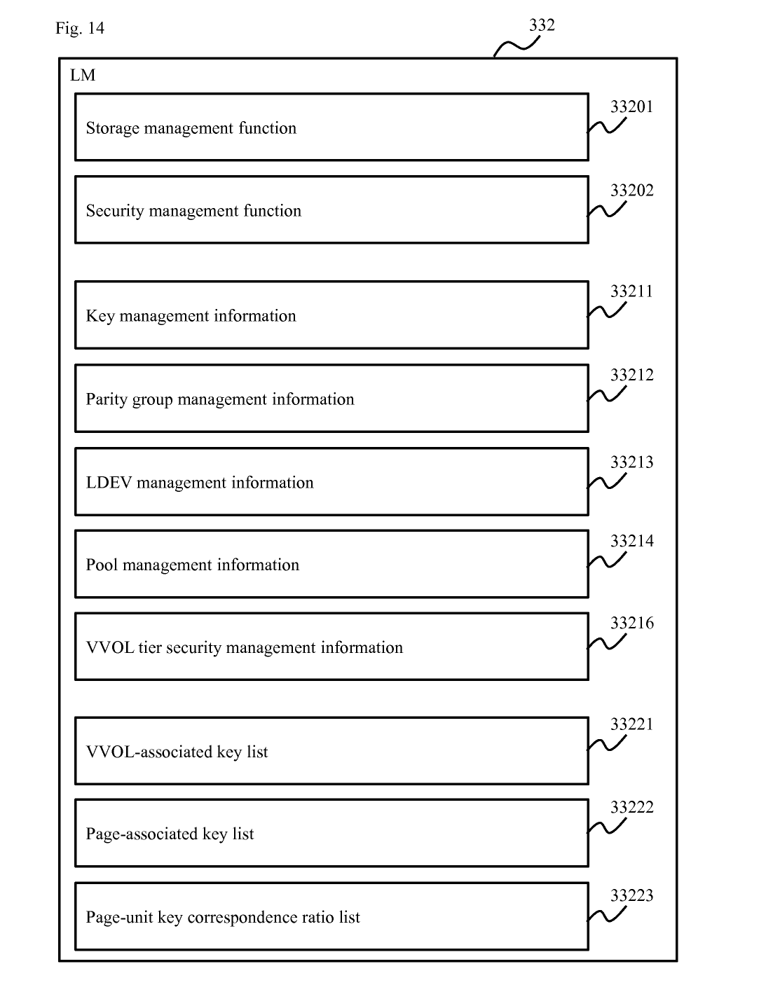

A third embodiment will be described using FIGS. 14 through 16. In this embodiment, a case that applies to a configuration for hierarchically managing, as a pool volume, an LDEV configured from physical storage devices 322 having various performance capabilities will be described. In addition, in this embodiment, the pool volumes comprising the pool are a mixture of pool volumes that need to be encrypted and those that do not, and, in addition, it is possible to configure the necessity for encryption for each VVOL tier. In this embodiment, a page is allocated on the basis of the encryption setting of the VVOL 327 when a write request for the VVOL 327 is received.

FIG. 14 shows an example of the logical configuration of the LM 332 in this embodiment. In addition to the example of the LM 332 logical configuration of the first embodiment shown in FIG. 3, in this embodiment, the LM 332 also comprises a security management function 33202 and VVOL tier security management information 33216.

The security management function 33202, which is configured to manage the necessity for encryption in the VVOL 327 on a tier-by-tier basis, has VVOL tier security management information 33216. The VVOL tier security information 33216 comprises VVOL tier security management information 33216 configured to manage the necessity for encryption for each tier of the VVOL. The system administrator can configure the VVOL tier security management information 33216 via the management computer 2 by using an interface provided by the security management function 33202.

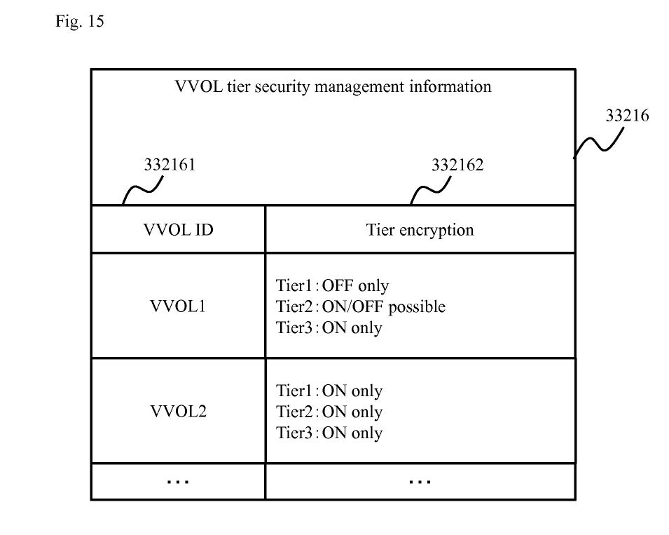

FIG. 15 shows an example of the configuration of the VVOL tier security management information 33216. The VVOL tier security management information 33216, for example, includes a VVOL ID column 332161 for managing an ID that enables the VVOL 327 to be uniquely identified, and a tier encryption setting column 332162 for managing the necessity for encryption for each pool tier.

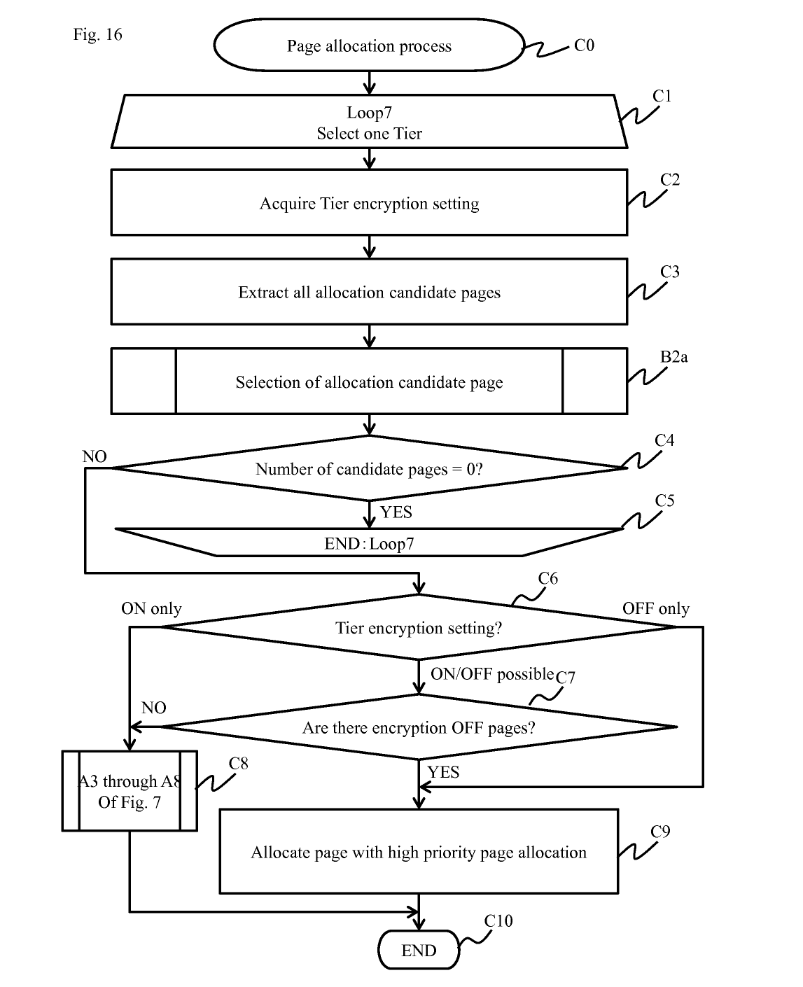

A page allocation process using this embodiment will be described using the flowchart of FIG. 16. The storage management function 33201 is configured to start this process when a write request for an area to which a page has yet to be allocated to the VVOL 327 is received from the host computer 1 (C0). The VVOL 327 for which there was a write request will be called the target VVOL 327.

The storage management function 33201 is configured to identify, in Loop 7 from Step C1 through Step C7, the page for which the encryption setting of the allocation candidate page corresponds to the encryption setting of the tier of the write-destination page in the target VVOL 327.

Specifically, the storage management function 33201 is configured to select one of the tiers from the high-level tiers in the pool (C1), and to perform the following processing for the relevant tier (target tier). The storage management function 33201 is configured to acquire from the security management function 33202 the target-tier encryption setting stored in the VVOL tier security management information 33216 (C2). The storage management function 33201 is configured to reference the pool management information 33214, and to extract all from the high-priority pages to be allocated to the write-target VVOL 327 (C3). The extracted pages will be called the allocation candidate page group.

In Step B2a, the storage management function 33201 is configured to extract allocation candidate pages for which the target-tier encryption settings correspond. This process changes each of Step B2-3 and Step B2-5 of FIG. 13 as described hereinbelow.

Regarding Step B2-3 as Step B2-3a, the storage management function 33201 is configured to reference the LDEV management information 33213, and to identify the parity group and tier to which the identified LDEV belongs. Regarding Step B2-5 as B2-5a, the storage management function 33201 is configured to compare the encryption setting in the target VVOL 327 of the tier identified in Step B2-3a to the encryption setting of the parity group identified in Step B2-4.

The storage management function 33201 is configured to confirm the number of allocation candidate pages (C4), and when the number of candidate pages is larger than 0 (C5), to subsequently perform Loop 7 for the high-level tier.

Alternatively, the storage management function 33201 is configured to end the Loop 7 when the number of candidate pages is 0 and to advance to Step C6. The storage management function 33201 is configured to confirm the encryption setting of the target VVOL 327 identified in Step C2 (C6), and when “ON/OFF possible” has been configured, to confirm whether there are any allocation candidate pages for which the encryption setting is OFF (C7). The storage management function 33201 is configured to advance to Step C8 when there are no allocation candidate pages for which the encryption setting is OFF, and to advance to Step C9 when there is an allocation candidate page for which the encryption setting is OFF.

The storage management function 33201 is configured to perform the page allocation processing shown in FIG. 7 when the encryption setting is “ON only” (C8). However, the storage management function 33201 is configured to skip Step A2 for extracting the allocation candidate pages, and to perform the processing of Step A3 and beyond for the allocation candidate page extracted up to Step C7 (C8). When the encryption setting is “OFF only”, the storage management function 33201 is configured to allocate to the VVOL a page of the allocation candidate pages having a high-level priority (C9), and to end the processing (C10).

This embodiment, which is configured in this manner, also achieves the same operational advantage as the first embodiment. In addition, in this embodiment, in a configuration in which the necessity for VVOL encryption can be configured for each tier, a page in the pool is allocated to the VVOL in accordance with the encryption setting of the write-destination area. Therefore, security can be efficiently improved.

### Embodiment 4

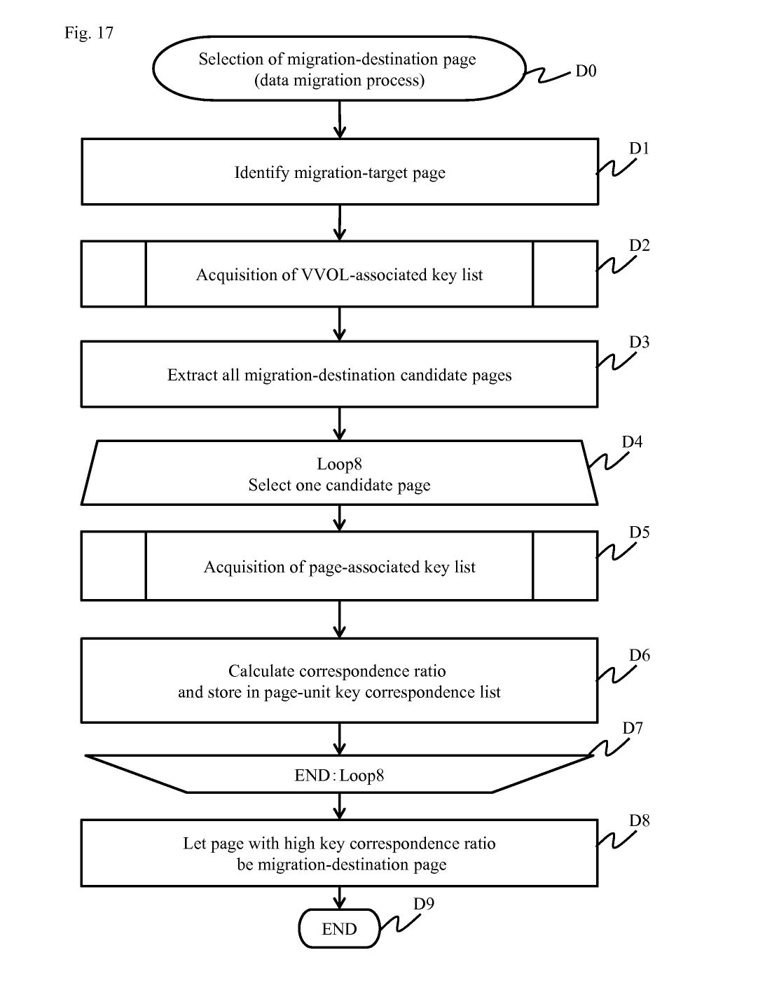

A fourth embodiment will be described using FIG. 17. In this embodiment, a case that applies to a data migration process will be described.

In the case of a hierarchical pool 326 managed by dividing pool volumes 324 of different performance into a plurality of tiers 325, a page is reallocated between tiers on the basis of the frequency of page unit access. For example, data in a frequently accessed page is migrated to a page belonging to a high-performance tier, and data in an infrequently accessed page is migrated to a page belonging to a low-performance tier. The present invention is applicable to the selection of a migration-destination page when executing a data migration process.

FIG. 17 is a flowchart showing the process for selecting a migration-destination page in a data migration process.

This processing boots up (D0) when a data migration process starts. The storage management function 33201 is configured to identify the migration-target page (D1).

The storage management function 33201 is configured to identify the VVOL 327 (target VVOL) that is the target of the data migration process, and to acquire the VVOL-associated key list 33221 for the target VVOL 327 (D2). The details of Step D2 conform to the content shown in FIG. 8.

The storage management function 33201 is configured to reference the pool management information 33214 and to extract all of the candidate pages capable of becoming the migration destination (D3). In Loop 8 from Step D4 through Step D7, the storage management function 33201 is configured to calculate the correspondence ratio between the encryption key to be used in the encryption of data to be stored in the migration-destination candidate page and the encryption key described in the VVOL-associated key list 33221 acquired in Step D2, and to create a page-unit key correspondence ratio list 33223.

Specifically, the storage management function 33201 is configured to extract one candidate page from the migration-destination candidate pages extracted in Step D3 (D4). The storage management function 33201 is configured to acquire the page-associated key list 33222 for the extracted candidate page (D5). The details of Step D5 conform to the content shown in FIG. 9.

The storage management function 33201 is configured to compare the VVOL-associated key list 33221 to the page-associated key list 33222, to calculate the ratio of encryption keys included in the page-associated key list 33222 that are included in the VVOL-associated key list 33221 as the key correspondence ratio, and to store the calculation result in the page-unit key correspondence ratio list 33223 (D6).

The storage management function 33201 is configured to end the Loop 8 (D7) and to advance to Step D8 when the Loop 8 processing has been performed for all the allocation candidate pages. The storage management function 33201 is configured to reference the page-unit key correspondence ratio list 33223, to select a page with a high priority and a high key correspondence ratio as the migration-destination page (D8), to migrate the data of the migration-target page to the selected page, and to end the processing (D9).

The high-priority page here is the page belonging to the tier that should be selected as the migration destination in a prescribed migration criterion. A case is assumed in which the criterion is that a frequently accessed page should be migrated to a high-level tier and an infrequently accessed page should be migrated to a low-level tier. For example, in a case where the migration-target page is frequently accessed, the migration-destination candidate page should be selected from the high-level tier. The selection as the migration-destination page of a page with a high key correspondence ratio from among the pages belonging to the high-level tier makes it possible to perform a data migration while curbing the number of encryption keys used in the VVOL.

The present invention is not limited to the embodiments described hereinabove. A person with ordinary skill in the art will be able to make various additions and changes without departing from the scope of the present invention.

For example, the present invention can also be understood as either a computer program invention or as a storage medium invention for storing a computer program as follows.
“A computer program (or storage medium for storing a computer program) for using a computer system as a storage system configured to provide a virtual logical volume to a host computer,
the above-mentioned computer program (or storage medium for storing a computer program) making it possible for the above-mentioned computer system to use a plurality of storage devices configured to provide physical storage areas and to be capable of encrypting data using mutually different encryption key information, a plurality of logical volumes configured on the basis of the above-mentioned physical storage areas of either one or a plurality of the above-mentioned storage devices, and at least one pool configured to manage a plurality of logical storage areas of a plurality of the above-mentioned logical volumes, and
realizing on the above-mentioned computer system a controller configured to provide the above-mentioned host computer with at least one virtual logical volume created on the basis of a plurality of logical storage areas managed by the above-mentioned pool, and, in accordance with a write request from the above-mentioned host computer, to allocate to the above-mentioned virtual logical volume any prescribed logical storage area of a plurality of the above-mentioned logical storage areas managed by the above-mentioned pool,
wherein the controller is configured to:
determine whether a prescribed instance has arrived;
when it has been determined that the above-mentioned prescribed instance has arrived, acquire first information regarding encryption key information associated with a logical storage area allocated to the above-mentioned virtual logical volume;

acquire second information regarding encryption information associated with a logical storage area capable of being allocated to the above-mentioned virtual logical volume from among a plurality of the above-mentioned logical storage areas managed in the above-mentioned pool; and
select, on the basis of the above-mentioned first information and the above-mentioned second information, a logical storage area to be allocated to the above-mentioned virtual logical volume.

### REFERENCE SIGNS LIST

1 Host computer
2 Management computer
3 Storage system
322 Storage device
323 Parity group
324 Logical volume (pool volume)
325 Tier
326 Pool
327 Virtual logical volume (VVOL)
33201 Storage management function
33202 Security management function

1. A storage system configured to provide a virtual logical volume to a host computer, comprising:
a plurality of storage devices configured to provide physical storage areas; and
a controller,
wherein the controller is configured to:
manage a plurality of logical volumes configured on the basis of physical storage areas of either one or a plurality of the storage devices, and at least one pool configured to manage a plurality of logical storage areas of a plurality of the logical volumes;
provide to the host computer at least one virtual logical volume created on the basis of a plurality of logical storage areas managed by the pool;
allocate to the virtual logical volume, in accordance with a write request from the host computer, any prescribed logical storage area from among a plurality of the logical storage areas managed by the pool; and
either a portion or all of the plurality of storage devices are configured to be able to encrypt data stored in the physical storage area by using respectively different encryption key information,
in a prescribed instance, select a logical storage area to be allocated to the virtual logical volume on the basis of first information regarding encryption key information associated with a logical storage area allocated to the virtual logical volume, and second information regarding encryption key information associated with a logical storage area capable of being allocated to the virtual logical volume from among a plurality of the logical storage areas managed in the pool, and, after ratio of the encryption key information that is shown in the second information included in the encryption key information that is shown in the first information among the logical storage area capable of being allocated to the virtual logical volume is calculated, on the basis of the calculated ratio.

2. A storage system according to claim 1, wherein the prescribed instance is either or both of an instance in which the logical storage area is allocated to the virtual logical volume in accordance with a write request from the host computer, and/or an instance in which data stored in a logical storage area allocated to the virtual logical volume is migrated, in accordance with a prescribed migration criterion, to another logical storage area managed by the pool.

3. (canceled)

4. A storage system according to claim 2, wherein a plurality of the virtual logical volumes is provided, and
the controller is configured to be able to configure either of an encryption mode for encrypting and storing data and a normal mode for storing data without performing encryption, for each of a plurality of the virtual logical volumes.

5. A storage system according to claim 4, wherein, for a virtual logical volume for which the encryption mode has been configured, the controller is configured to select, in the prescribed instance, the logical storage area to be allocated to the virtual logical volume on the basis of the first information and the second information.

6. A storage system according to claim 5, wherein the controller is configured to store an encryption key information management table for managing encryption key information to be configured for each of a plurality of the storage devices, and a corresponding relationship management table for managing a corresponding relationship between a storage area of the virtual logical volume, the logical storage area managed by the pool, and the storage device, and to output to an external apparatus information regarding the encryption key information associated with the virtual logical volume by using the encryption key information management table and the corresponding relationship management table.

7. A storage system according to claim 6, wherein a plurality of storage devices with different performance capabilities is included in the plurality of storage devices,
the pool is configured to hierarchically manage a plurality of logical volumes with different performance capabilities provided by the plurality of storage devices with different performance capabilities, and
the controller is configured to configure either the encryption mode or the normal mode for each tier corresponding to the virtual logical volume, and when the prescribed instance has occurred for a tier configured to the encryption mode, to select the logical storage area to be allocated to the virtual logical volume on the basis of the first information and the second information.

8. A storage system according to claim 2, wherein the controller is configured to:
extract a logical storage area to be extracted using a prescribed extraction criterion from a plurality of logical storage areas managed by the pool as the logical storage area capable of being allocated to the virtual logical volume; and
select, from among the extracted logical storage areas, the logical storage area to be allocated to the virtual logical volume on the basis of a the ratio.

9. A method for controlling a storage system configured to provide a virtual logical volume to a host computer,
the storage system having:
a plurality of storage devices configured to provide physical storage areas and to be able to encrypt data by using mutually different encryption key information;
a plurality of logical volumes configured on the basis of the physical storage areas of one or a plurality of the storage devices;
at least one pool configured to manage a plurality of logical storage areas of a plurality of the logical volumes; and
a controller configured to provide the host computer with at least one virtual logical volume created on the basis of a plurality of logical storage areas managed by the pool, and, in accordance with a write request from the host computer, to allocate to the virtual logical volume any prescribed logical storage area of a plurality of the logical storage areas managed by the pool,
the storage system control method comprising operating the controller:
to determine whether a prescribed instance has arrived;
when it has been determined that the prescribed instance has arrived, to acquire first information regarding encryption key information associated with a logical storage area allocated to the virtual logical volume;
to acquire second information regarding encryption key information associated with a logical storage area capable of being allocated to the virtual logical volume from among a plurality of the logical storage areas managed in the pool; and
to select, on the basis of the first information and the second information, and, after ratio of the encryption key information that is shown in the second information included in the encryption key information that is shown in the first information among the logical storage area capable of being allocated to the virtual logical volume is calculated, on the basis of the calculated ratio, a logical storage area to be allocated to the virtual logical volume.

10. A storage system control method according to claim 9, wherein the prescribed instance is either or both of an instance in which the logical storage area is allocated to the virtual logical volume in accordance with a write request from the host computer, and/or an instance in which data stored in a logical storage area allocated to the virtual logical volume is migrated, in accordance with a prescribed migration criterion, to another logical storage area managed by the pool.

11. A storage system control method according to claim 10, wherein the controller is configured to store an encryption key information management table for managing encryption key information to be configured for each of a plurality of the storage devices, and a corresponding relationship management table for managing a corresponding relationship between a storage area of the virtual logical volume, the logical storage area managed by the pool, and the storage device, and to output to an external apparatus information regarding the encryption key information associated with the virtual logical volume by using the encryption key information management table and the corresponding relationship management table.
